(19) United States
(12) Patent Application Publication
(10) Pub. No.: US 2012/0253835 A1
(43) Pub. Date: Oct. 4, 2012

(54) METHODS, APPARATUSES AND COMPUTER PROGRAM PRODUCTS FOR FACILITATING QUALITY REPORTING AND ALERTS MANAGEMENT

(75) Inventors: Carrie L. Tracy, Anthem, AZ (US); Abel Martin Robertson, Oakland, CA (US); Aron Ralston, Alameda, CA (US)

(73) Assignee: McKesson Financial Holdings

(21) Appl. No.: 13/077,201

(22) Filed: Mar. 31, 2011

(51) Int. Cl. G06Q 50/00

(52) U.S. Cl. 705/2

(57) ABSTRACT

An apparatus is provided for generating one or more customizable health care alerts. The apparatus includes at least one memory and at least one processor configured to generate one or more customizable health care alerts based in part on a defined query. The processor is further configured to cause the apparatus to define one or more actions to be monitored for a plurality of patients meeting criteria of the defined query and assigning the defined actions to the generated alerts to enable a status of the actions to be tracked. Corresponding computer program products and methods are also provided.

### TECHNOLOGICAL FIELD

Embodiments of the invention may relate to a mechanism of generating one or more health care alerts and more particularly relate to a method, apparatus and computer program product for enabling generation of one or more customizable health care alerts.

### BACKGROUND

Currently, health care professionals may need timely and easy access to clinical knowledge that does not interrupt a normal workflow of the health care professionals in order to improve health management decisions. In this regard, health care professionals may need assistance with monitoring patient conditions and care plans to ensure patients receive the appropriate level of proactive care and to notify the patients of potential problems.

At present, clinical decision support (CDS) systems may assist health care professionals with some of these tasks. Additionally, for example, existing CDS systems may assist health care professionals with decision making tasks, such as, for example, determining a diagnosis of a patient and selection of one or more medications.

Currently, existing CDS systems may typically be predefined with one or more static alerts designed to provide or report designated information to health care professionals such as, for example, lists of possible diagnoses, drug interaction alerts, or preventive care reminders. However, health care professionals may desire to be informed and alerted about health care information that may not be designated, or customizable, for reporting by an existing CDS system.

In view of the foregoing, it may be beneficial to provide an efficient and reliable mechanism for enabling generation of one or more customizable health care alerts.

### BRIEF SUMMARY

A method, apparatus and computer program product are therefore provided that may enable the provision of an efficient and reliable mechanism for generating one or more customizable health care alerts. An example embodiment may enable one or more health care professionals (e.g., clinicians (e.g., nurses, physicians, therapists, etc.)) the ability to create their own tailored alerts. In this regard, the exemplary embodiments may enable a health care professional(s) the ability to construct and build the alerts according to the preferences and desires of the health care professional(s) as well as information that they wish to monitor.

In generating the customizable health care alerts, an exemplary embodiment may utilize aggregated medical data, associated with one or more patients, received from various different entities or sources. In this regard, an exemplary embodiment may enable a health care entity to build customizable health care alerts based on medical data related to patients that the health care entity may not have originated or initially generated.

As such, an example embodiment may utilize enterprise level data that may be aggregated into records from multiple sources that may drive the basis for clinical decision support and for enabling customization of health care alerts. For instance, the aggregated data may be analyzed for health indicators outside of a patient interaction in order to utilize the data to facilitate generation of the alerts. As such, a device of a health care facility may enable external health care systems, practices, and providers to establish a set of automated search criteria to create customizable patient level care alerts. In this regard, one or more users may determine the alert attributes including, but not limited to a level of visibility (e.g., designating who may have access to the alert(s) (e.g., other physicians, practices, external systems, etc.), the scope of the alert, clinical criteria, frequency of occurrences and recurrences, escalation time, destination time and automated actions. For instance, an example embodiment may enable provision of a system enabling predetermined automated actions that the system may perform on behalf of a health care professional based on a generated alert(s). For purposes of illustration and not of limitation, a health care professional may utilize an example embodiment to create an alert(s) to monitor patients taking Coumadin and instances in which the patients miss their bi-weekly blood test. In this regard, the health care professional(s) may configure the system to automatically send a secure message to the patient as soon as the blood test is overdue.

An example embodiment may allow the users to create a new custom alerts based on one or more standard measures without redefining all of the criteria contained in the standard measures. In this manner, a user may configure recommended and automated actions to be conducted on their behalf for generating the customizable alerts. By utilizing an example embodiment of the invention, a health care entity may greatly reduce its reliance on manual workflows.

In one exemplary embodiment, a method for generating one or more customizable health care alerts is provided. The method may include generating one or more customizable health care alerts based in part on a defined query and defining one or more actions to be monitored for a plurality of patients meeting criteria of the defined query. The method may further include assigning the defined actions to the generated alerts to enable a status of the actions to be tracked.

In another example embodiment, an apparatus for generating one or more customizable health care alerts is provided. The apparatus may include a memory and a processor configured to cause the apparatus to generate one or more customizable health care alerts based in part on a defined query and define one or more actions to be monitored for a plurality of patients meeting criteria of the defined query. The processor is further configured to cause the apparatus to assign the defined actions to the generated alerts to enable a status of the actions to be tracked.

In another exemplary embodiment, a computer program product for generating one or more customizable health care alerts is provided. The computer program product includes at least one computer-readable storage medium having computer-executable program code instructions stored therein. The computer-executable program code instructions may include program code instructions configured to generate one or more customizable health care alerts based in part on a defined query. The computer program product may further include program code instructions configured to define one or more actions to be monitored for a plurality of patients meeting criteria of the defined query. The computer program product may further include program code instructions configured to assign the defined actions to the generated alerts to enable a status of the actions to be tracked.

Embodiments of the invention may provide a method, apparatus and computer program product for enabling an efficient and reliable manner in which to generate one or more customizable health care alerts. As such, health care professionals may enjoy improvements in tailoring health care alerts based on their needs and desires.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of a system according to an exemplary embodiment of the invention;

FIG. 2 is a schematic block diagram of communication device according to an exemplary embodiment of the invention;

FIG. 3 is a schematic block diagram of a computing device according to an exemplary embodiment of the invention; and

FIG. 4 is a flowchart for generating one or more customizable health care alerts according to an exemplary embodiment of the invention;

FIG. 5 is a diagram of an illustration of web page infrastructure according to an exemplary embodiment of the invention;

FIG. 6 is a diagram of an alert status user interface according to an exemplary embodiment of the invention;

FIG. 7 is a diagram of a build query user interface according to an exemplary embodiment of the invention;

FIGS. 8-13 are diagrams of user interfaces associated with the build query user interface according to an exemplary embodiment of the invention;

FIG. 14 is a diagram of a user interface for building one or more alerts according to an example embodiment of the invention.

FIG. 15 is a diagram of a user interface for generating one or more reports according to an exemplary embodiment of the invention; and

FIG. 16 is another flowchart for generating one or more customizable alerts according to an example embodiment of the invention.

### DETAILED DESCRIPTION OF THE INVENTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

### General System Architecture

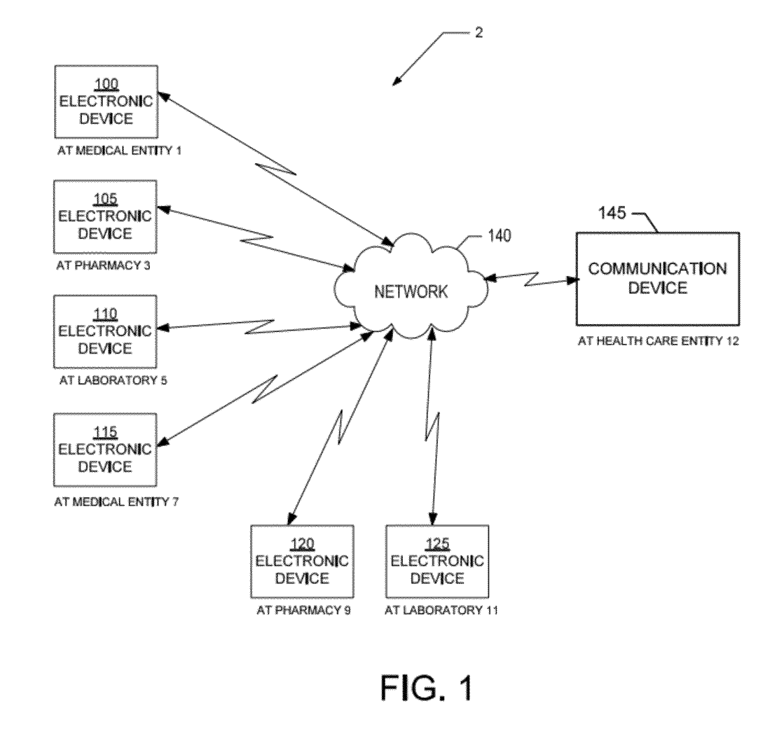

Reference is now made to FIG. 1, which is a block diagram of a system according to exemplary embodiments. As shown in FIG. 1, the system 2 may include one or more electronic devices 100, 105, 110, 115, 120 and 125 (e.g., personal computers, laptops, workstations, servers, personal digital assistants, smart devices and the like, etc.) which may access one or more network entities such as, for example, a communication device 145 (e.g., a server), or any other similar network entity, over a network 140, such as a wired local area network (LAN) or a wireless local area network (WLAN), a metropolitan network (MAN) and/or a wide area network (WAN) (e.g., the Internet). In this regard, the communication device 145 is capable of receiving data from and transmitting data to the electronic devices 100, 105, 110, 115, 120 and 125 via network 140. In one exemplary embodiment, the electronic devices 100, 105, 110, 115, 120 may be utilized by clinicians, nurses, pharmacists, physicians, physical therapists and/or any other suitable health care professionals. The electronic devices 100, 105, 110, 115, 120, 125 may be maintained by one or more health care institutions. For instance, the electronic device 100 may be maintained by a medical entity 1, the electronic device 105 may be maintained by a pharmacy 3, the electronic device 110 may be maintained by the laboratory 5. Additionally, the electronic device 115 may be maintained by a medical entity 7, the electronic device 120 may be maintained by a pharmacy 9 and the electronic device 125 may be maintained by the laboratory 11. In an exemplary embodiment, the communication device 145 may be maintained by a health care entity 12. In an alternative exemplary embodiment, the communication device 145 may be maintained by any other suitable entity.

The communication device 145 may communicate with the electronic devices 100, 105, 110, 115, 120, 125. In this regard, the communication device 145 may receive medical information from and may transmit medical information to the electronic devices 100, 105, 110, 115, 120, 125. The medical information may be utilized by the communication device 145 to generate one or more customizable health care alerts. The customizable health care alerts may be associated with respective patients. The respective patients may meet the criteria of a defined query definition associated with a health care alert(s). The patients meeting the query definition may be monitored by the communication device 145 on the basis of an associated alert(s). The customizable health care alerts may be generated based in part on the aggregated medical information received from one or more of the electronic devices 100, 105, 110, 115, 120 and 125, as described more fully below. The aggregated medical information may be associated with respective patients.

It should be pointed out that although FIG. 1 shows six electronic devices 100, 105, 110, 115, 120, 125 and one communication device 145 any suitable number of electronic devices 100, 105, 110, 115, 120, 125 and communication devices 145 may be part of the system of FIG. 1 without departing from the spirit and scope of the invention.

### Communication Device

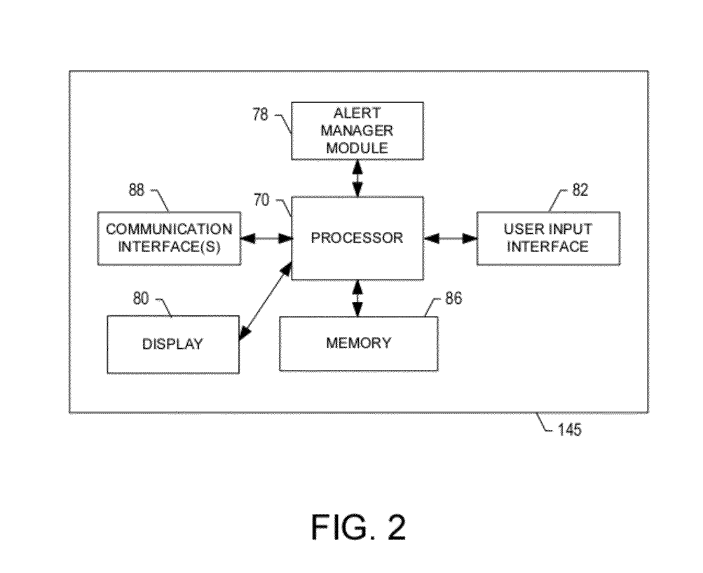

FIG. 2 illustrates a block diagram of a communication device according to an exemplary embodiment of the invention. The communication device 145 may, but need not, be a network entity such as, for example, a server. The communication device 145 includes various means for performing one or more functions in accordance with exemplary embodiments of the invention, including those more particularly shown and described herein. It should be understood, however, that one or more of the communication devices may include alternative means for performing one or more like functions, without departing from the spirit and scope of the invention. More particularly, for example, as shown in FIG. 2, the communication device 145 may include a processor 70 connected to a memory 86. The memory may comprise volatile and/or non-volatile memory, and typically stores content (e.g., media content), data, information or the like.

For example, the memory may store content transmitted from, and/or received by, the electronic devices 100, 105, 110, 115, 120 and 125. In this regard, in an exemplary embodiment, the memory 86 may store data received from various disparate sources. For example, the memory 86 may store medical information received by the communication device 145 from the electronic devices of the medical entity 1, the pharmacy 3, the laboratory 5, the medical entity 7, the pharmacy 9 and the laboratory 11 as well as any other suitable entities. The medical information may include medical diagnoses, laboratory results, medical tests or measurements, medical chart information (e.g., clinician assessments, vital signs, etc.), prescription data, medical imaging data (e.g., X-rays of the human body), alert information and any other suitable information.

The medical information associated with the medical diagnoses, laboratory results, medical tests or measurements, medical chart information, prescription data, medical image data and alert information may also include data corresponding to dates and times this information was created or the actual dates and times of actual events (e.g., actual date and time of a laboratory result) associated with the generation of this information. Additionally, the medical information may also include, but is not limited to, data associated with admission of a patient into a medical institution and a corresponding date and time of admission and/or discharge of a patient from a medical facility as well as a corresponding date and time of discharge.

Additionally, the medical information may include, but is not limited to, one or more medical events or procedures (e.g., surgical procedures) and may indicate one or more dates and times of these events or procedures, transfers from different medical units (e.g., critical to telemetry, critical to medical surgery (Med-Surg), telemetry to critical, etc.) within a facility (e.g., hospital) and corresponding date and times of such transfer(s), expected or forecasted discharge dates and times, tasks that remain unmet, one or more pre-admission events and corresponding dates and times as well as any other suitable medical information. The medical information received by the communication device 145 from the electronic devices 100, 105, 110, 115, 120, 125 may include one or more unique patient identifiers. The patient identifiers may identify respective patients. In an example embodiment, the patient identifiers may be one or more unique alphanumeric characters used to denote the identity of respective patients. For instance, a patient identifier such as, for example, 24DEF703 may identify a patient such as, for example, John Doe (e.g., a fictitious person as referred to herein). Additionally, or alternatively Medical Record Numbers (MRNs) may be utilized as patient identifiers to identify corresponding patients.

Also for example, the memory 86 typically stores client applications, instructions, algorithms or the like for execution by the processor 70 to perform steps associated with operation of the communication device 145 in accordance with embodiments of the invention. As explained below, for example, the memory 86 may store one or more client applications such as for example software (e.g., software code also referred to herein as computer code).

The processor 70 may be embodied in a variety of ways. For instance, the processor 70 may be embodied as a controller, coprocessor, microprocessor of other processing devices including integrated circuits such as, for example, an application specific integrated circuit (ASIC), a field programmable gate array (FPGA). In an exemplary embodiment, the processor may execute instructions stored in the memory 86 or otherwise accessible to the processor 70.

The communication device 145 may include one or more logic elements for performing various functions of one or more client applications. In an exemplary embodiment, the communication device 145 may execute the client applications. The logic elements performing the functions of one or more client applications may be embodied in an integrated circuit assembly including one or more integrated circuits (e.g., an ASIC, FPGA or the like) integral or otherwise in communication with a respective network entity (e.g., computing system, client, server, etc.) or more particularly, for example, a processor 70 of the respective network entity.

In addition to the memory 86, the processor 70 may also be connected to at least one interface or other means for displaying, transmitting and/or receiving data, content or the like. The interface(s) can include at least one communication interface 88 or other means for transmitting and/or receiving data, content or the like. In this regard, the communication interface 88 may include, for example, an antenna and supporting hardware and/or software for enabling communications with a wireless communication network. For example, the communication interface(s) may include a first communication interface for connecting to a first network, and a second communication interface for connecting to a second network. In this regard, the communication device is capable of communicating with other devices such as, for example, electronic devices 100, 105, 110, 115, 120, 125 over one or more networks (e.g., network 140) such as a Local Area Network (LAN), wireless LAN (WLAN), Wide Area Network (WAN), Wireless Wide Area Network (WWAN), the Internet, or the like. Alternatively, the communication interface can support a wired connection with the respective network.

In addition to the communication interface(s), the interface(s) may also include at least one user interface that may include one or more earphones and/or speakers, a display 80, and/or a user input interface 82. The user input interface, in turn, may comprise any of a number of devices allowing the entity to receive data from a user, such as a microphone, a keypad, keyboard, a touch display, a joystick, image capture device, pointing device (e.g., mouse), stylus or other input device.

In an exemplary embodiment, the processor 70 may be in communication with and may otherwise control an alert manager module 78. The alert manager module 78 may be any means such as a device or circuitry operating in accordance with software or otherwise embodied in hardware or a combination of hardware and software thereby configuring the device or circuitry (e.g., a processor, controller, microprocessor or the like) to perform the corresponding functions of the alert manager module 78, as described below. In examples in which software is employed, a device or circuitry (e.g., processor 70 in one example) executing the software forms the structure associated with such means. As such, for example, the alert manager module 78 may be configured to, among other things, generate one or more customizable health care alerts based in part on integrated or aggregated data received from multiple different entities/sources such as, for example, the electronic devices 100, 105, 110, 115, 120, 125 maintained, respectively, by the medical entity 1, the pharmacy 3, the laboratory 5, the medical entity 7, the pharmacy 9 and the laboratory 11, as described more fully below.

In this regard, in an example embodiment, the alert manager module 78 may provide the logic to enable one or more health care professionals to create their own customizable alerts for monitoring medical data across a patient population, for example. By utilizing aggregated data medical data received from different entities/sources (e.g., the medical entity 1, the pharmacy 3, the laboratory 5, the medical entity 7, the pharmacy 9 and the laboratory 11) to generate the customizable health care alerts, the alert manager module 78 may enable a health care professional (e.g., a physician) to generate customizable alerts based on medical data that may not be initially stored locally by a device (e.g., the electronic device 100) of an entity (e.g., a hospital) associated with the health care professional.

### Computing Device

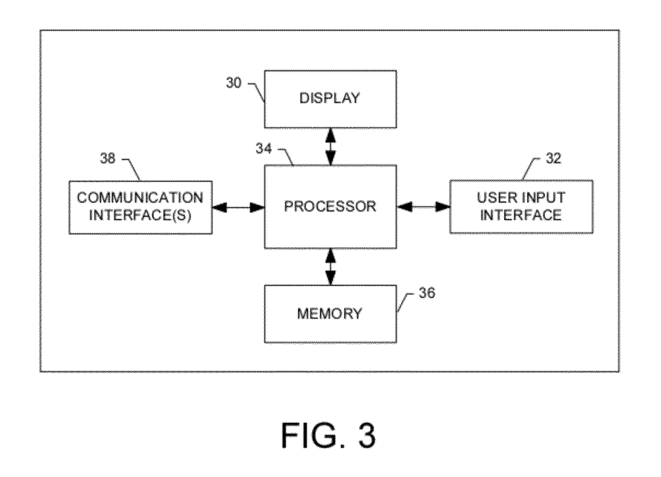

Referring now to FIG. 3, a block diagram of a computing device according to an exemplary embodiment is provided. The computing device is capable of operating as any of electronic devices 100, 105, 110, 115, 120 and 125. In this regard, the electronic devices 100, 105, 110, 115, 120, and 125 may comprise the elements of the computing device of FIG. 3. As shown in FIG. 3, the computing device may include a processor 34 connected to a memory device 36. The memory device 36 (also referred to herein as memory 36) may comprise volatile and/or non-volatile memory, and may store content, information, data or the like. For example, the memory device 36 typically stores content transmitted from, and/or received by, the computing device. Additionally, the memory device 36 may store client applications, software (e.g., software code) algorithms, instructions or the like for the processor 34 to perform steps associated with operation of the computing device.

The memory device 36 may store medical information (e.g., medical diagnoses, laboratory results, medical images, medications, etc.) associated with one or more patients. The medical information may include one or more patient identifiers identifying respective patients (e.g., John Doe). The medical information may also include one or more codes that may be defined to designate and identify medical data. For example, the unique codes may designate and identify specific diseases (e.g., diabetes), diagnoses, injuries, conditions, types of medications (e.g., amoxicillin), types of laboratory results and any other suitable medical data. In an exemplary embodiment, at least some of the codes may be International Statistical Classification of Diseases and Related Health Problems (ICD) 9 (ICD-9) codes which may classify diseases, a variety of signs, symptoms, abnormal findings, complaints, causes of injury or disease, social circumstances and any other suitable health care data. In this regard, health conditions may be assigned a unique category and a code (e.g., six characters in length, or any other suitable length).

The codes may also be associated with, or may include, one or more defined quality measures that may be utilized to drive or assign specific items to be measured (e.g., performing an eye exam, etc.) for an individual patient. In an example embodiment, the measures may include but are not limited to Centers for Medicare/Medicaid Services (CMS) Physician Quality Reporting Initiative (PQRI) measures, National Center for Quality Assurance (NCQA) National Quality Forum (NQF) measures and any other suitable measures. In an example embodiment, the defined measures may include data associated with numerator criteria and denominator criteria. The denominator criteria may include data defining a patient population that may apply to a corresponding measure, which may be based on a medical condition/disease, etc. (e.g., diabetes). The numerator criteria may be associated with data indicating a percentage of patients that meet the goals of the measure.

In an instance in which medical information that may include the codes and the defined measures may be sent to the communication device 145, by the processor 34, the alert manager module 78 may detect a code(s) with a defined quality measure(s). In this regard, the alert manager module 78 may utilize the data associated with the detected code (e.g., PQRI codes, NQF codes), in part, to generate one or more customizable health care alerts. For example, the detected code(s) may be utilized by the alert manager module 78 to establish a query definition for one or more alerts. The query definition may define the criteria for one or more alerts to be generated, as described more fully below.

The processor 34 may be connected to at least one communication interface 38 or other means for displaying, transmitting and/or receiving data, content, information or the like. In this regard, the communication interface 38 may be capable of connecting to one or more networks. The computing device may also include at least one user input interface 32 that may include one or more speakers, a display 30, and/or any other suitable devices. For instance, the user input interface 32 may include any of a number of devices allowing the computing device to receive data from a user, such as a keyboard, a keypad, mouse, a microphone, a touch screen display, or any other input device.

The processor 34 may send medical information associated with one or more patients to the communication device 145 in response to determining that medical information is available for corresponding patients. In an example embodiment, the processor 34 may automatically send medical information associated with one or more patients to the communication device 145 in response to determining that medical information for a patient(s) is available. The processor 34 may determine that medical information is available in response to determining that medical data associated with a patient identifier(s) identifying a patient(s) is stored in a memory (e.g., memory device 36). In this regard, when the processor 34 detects newly stored data, in the memory, that is associated with a patient(s), the processor 34 may automatically send the data to the communication device 145.

### Exemplary System Operation

Exemplary embodiments of the invention may provide an efficient and reliable mechanism for generating one or more customizable health care alerts. In this regard, an example embodiment may provide an alert management system with an alert manager module enabling one or more health care professionals to build their own customizable health care alerts based on information of relevance to the health care professionals.

In this regard, for example, the health care professionals may utilize the alert manager module to monitor medical information across their patient population for alerting when specific conditions are met. The health care professionals may utilize these customized health care alerts to be proactive about the prevention of health care problems of corresponding patients.

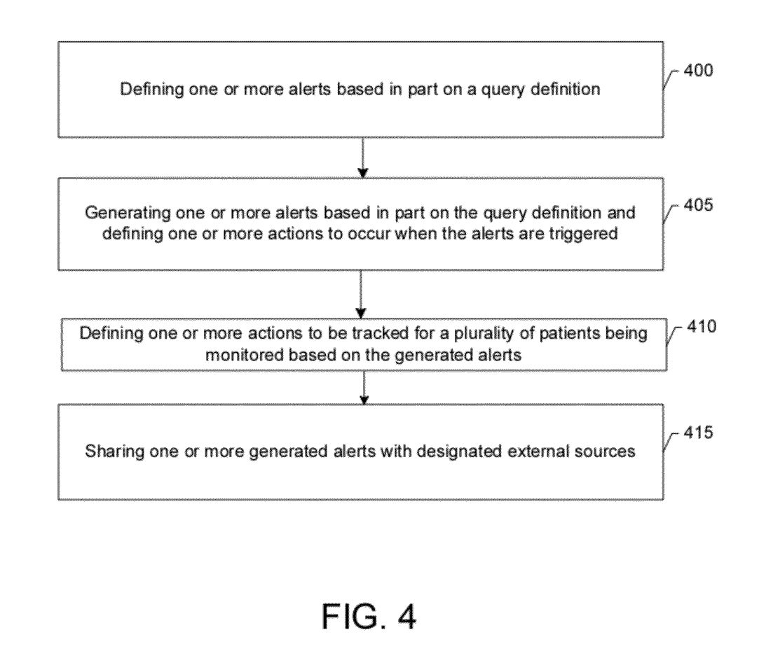

Reference will now be made to FIG. 4, which illustrates an example method of customizing one or more health care alerts according to an example embodiment. At operation 400, an apparatus (e.g., alert manager module 78) may enable defining of one or more alerts based in part on a query definition. The query definition may be defined by a health care professional, in response to the apparatus receiving input of the definition by a health care professional via a user interface (e.g., user input interface 82). The query definition may, but need not, be based on one or more dynamically defined questions related to a set or group of patients. For purposes of illustration and not of limitation, a defined question may be “Find all patients between ages 18 through 65 that are diagnosed with diabetes and taking Avandia medication.” In this regard, the apparatus (e.g., alert manager module 78) may utilize this query language associated with the defined question to search a memory (e.g., memory 86) for the group of patients desired to be monitored.

At operation 405, the apparatus (e.g., alert manager module 78) may generate one or more alerts based in part on the defined query definition and may define one or more actions to occur when the alerts are triggered. The apparatus may define the actions to occur when the alerts are triggered in response to receipt of input from a user input interface (e.g., user input interface 82). The receipt of input from the user input interface may be received as a health care professional utilizes the user input interface to input corresponding data specifying the definitions for the actions. In this regard, a health care professional may utilize the apparatus to define whether a corresponding alert(s) is critical or non-critical. If an alert is defined as critical, a defined action may be for the apparatus (e.g., alert manager module 78) to alert a device (e.g., electronic device 100) of the health care professional via a message such as, for example, a secured email message. It should be pointed out that any other suitable message (e.g., short messaging service (SMS) message, Health Level 7 (HL7) message, Multimedia Messaging Service (MMS) message, etc.) may be utilized to alert the device of the health care professional. As an example, presume that an alert associated with monitoring patients that have missed their two week blood exam while taking Coumadin is defined as critical. In this regard, the apparatus (e.g., alert manager module 78) may send a device of a health care professional a secured email message indicating the patients that missed the two week blood exam.

By utilizing the apparatus (e.g., alert manager module 78) to define what type of specific alerts that the health care professional wants to be informed about, the health care professional may not suffer from alert fatigue since the health care professional may know that when he receives an alert it is because he specified that the alert relates to some information that he desires to be informed about regarding patients.

The health care professional may also designate whether they want the generated alerts shared with others (e.g., other health care professionals). For example, the health care professional may utilize a user input interface to specify whether other health care professionals of an entity (e.g., medical clinic) associated with the health care professional may receive the alerts relating to a corresponding group of patients. Also, the health care professional may utilize the user input interface to designate whether the alert(s) is to be shared with an external source/system (e.g., medical entity 7).

At operation 410, the apparatus (e.g., alert manager module 78) may define one or more actions to be tracked for a plurality of patients being monitored based on the generated alerts. The apparatus may define the actions to be tracked for the patients in response to receipt of data, via a user input interface, which a health care professional may use to define the actions. In this regard, for a group of patients determined by the apparatus to correspond to a defined query question, the apparatus may specify the actions to be tracked or monitored on behalf of the patients. For example, an action may specify to send a letter to the corresponding patients, send a secure email message to the patients, to call the patients or perform any other suitable actions to be tracked. In this regard, for each patient in a corresponding group, the apparatus may track the progress of the alert(s). As an example, in an instance in which the apparatus may be utilized by a health care professional to define that an action such as delivery of an email to patients should be tracked, the apparatus may verify that the corresponding emails were received by the patients. In an example embodiment, the apparatus may determine that the emails were received by the patients in response to receiving one or more delivery receipts.

At operation 415, the apparatus (e.g., alert manager module 78) may share one or more generated alerts with one or more designated external sources or systems. In this regard, for example, if a condition associated (e.g., a diabetic patient that has not been examined in 6 months) with a generated alert(s) is met, the apparatus may send the corresponding alert to a designated external source that desired to receive the alert(s). As such, the apparatus may send the generated alert(s) to devices (e.g., electronic devices 100, 105) of the designated sources (e.g., medical entity 1, pharmacy 3) when the condition is met. A health care professional of the designated source may utilize a device to customize the shared alert by changing one or more definitions defined for the alert.

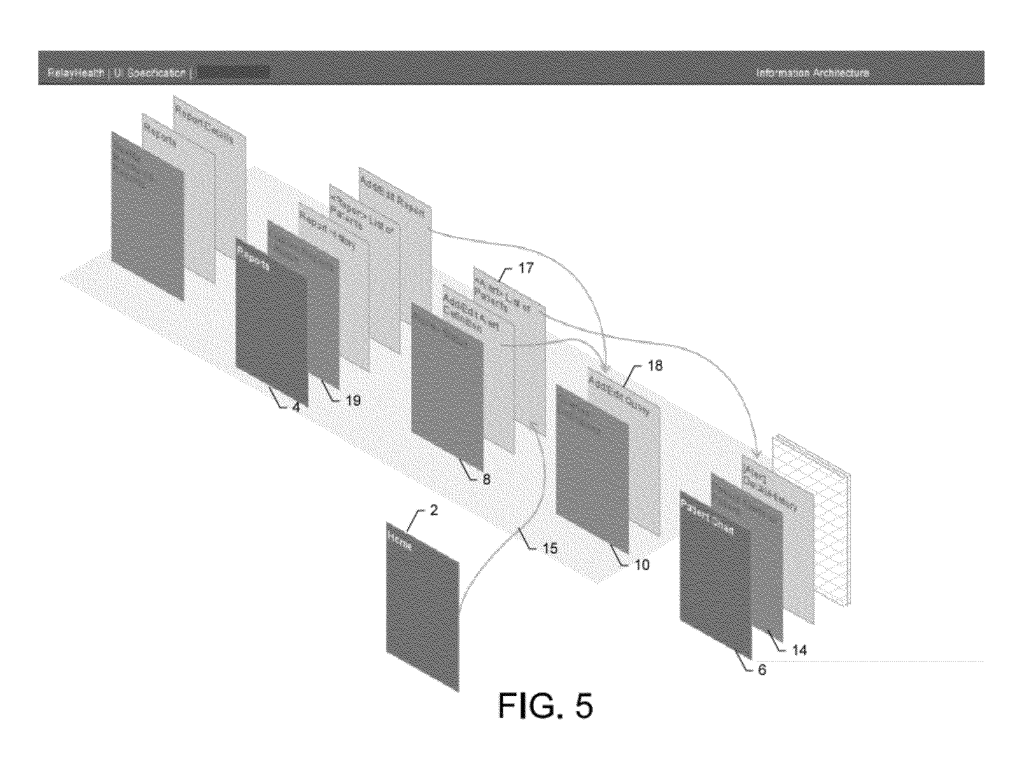

Referring now to FIG. 5, a diagram depicting an architecture structure for one or more web pages according an example embodiment is provided. In the example embodiment of FIG. 5, the web pages may be generated by the alert manager module 78. The web pages may be structured in an architecture according to a layered tier/level hierarchy. In this regard, one or more web pages (e.g., home page 2) higher in the layered tier/level may be accessed first and then web pages in a next highest tier/level (e.g., reports page 4 and patient chart page 6) may be accessible in response to selecting a web page(s) (e.g., home page 2) in the higher tier/level. The home page 2, corresponding to a web site for example, may be accessed first in order to obtain access to other web pages (e.g., reports page 4, patient chart page 6, etc.) associated with the web site.

In this regard, upon accessing the home page 2, a user (e.g., a health care professional) may be notified if there are any alerts (e.g., 5 critical alerts) to view. In order to access the alerts, generated by the alert manager module 78, a user may navigate to and select the reports page 4 to access the alerts status page 8, which is a page lower in the layered tier/level. In response to accessing the alerts status page 8, via a pointing device (e.g., mouse, etc.) or the like of a user input interface (e.g., user input interface 32), the alert manager module 78 may enable provision of display of the available alerts and a corresponding list of patients associated with the alerts. Additionally, a user may access the queries definition page 10 to add a new query or edit an existing query via the add/edit query page 12.

In response to receipt of a selection of the customer report page 19, the alert manager module 78 may enable a user to view a report history in a report. In this regard, selection of the customer report page 19 may trigger the alert manager module 78 to generate one or more on demand reports. The alert manager module 78 may generate an on demand report in response to receipt of an indication of a selection of one or more of the queries. In this regard, for example, in an instance in which a user may wish to view information relating to patients that smoke cigarettes, the user may select the customer report page 19 and a corresponding query and in response to receipt of the selection, the alert manager module may generate a report indicating health information of the patients.

In response to selecting the patient chart page 6, the alert manager module 78 may enable access to a patient specific web page such as, for example, the patient alerts for patient page 14 and may view detailed history of alerts for individual patients.

In this regard, for example, a user may navigate to an individual patient of the patient alerts for patient page 14 and view the alert history and the actions corresponding to those alerts at any time for a particular patient. As an example, presume a user (e.g., a health care professional (e.g., a physician)) knows that a particular patient (e.g., John Doe) has high blood sugar associated with diabetes. In this regard, the user may access the patient alerts for patient page 14 at any time and may check the high blood sugar of the patient and may look at alert history to monitor the progress of the patient.

A user may select the queries definitions page 10 to view one or more defined query definitions. In response to receipt of a selection of the queries definitions page 10, the alert manager module 78 may enable access to the add/edit query page 18. Upon accessing the add edit query page, the user may add new query definitions or edit existing query definitions. It should also be pointed out that the home page 2 may include a hyperlink 15 to obtain direct access to the alert list of patients page 17.

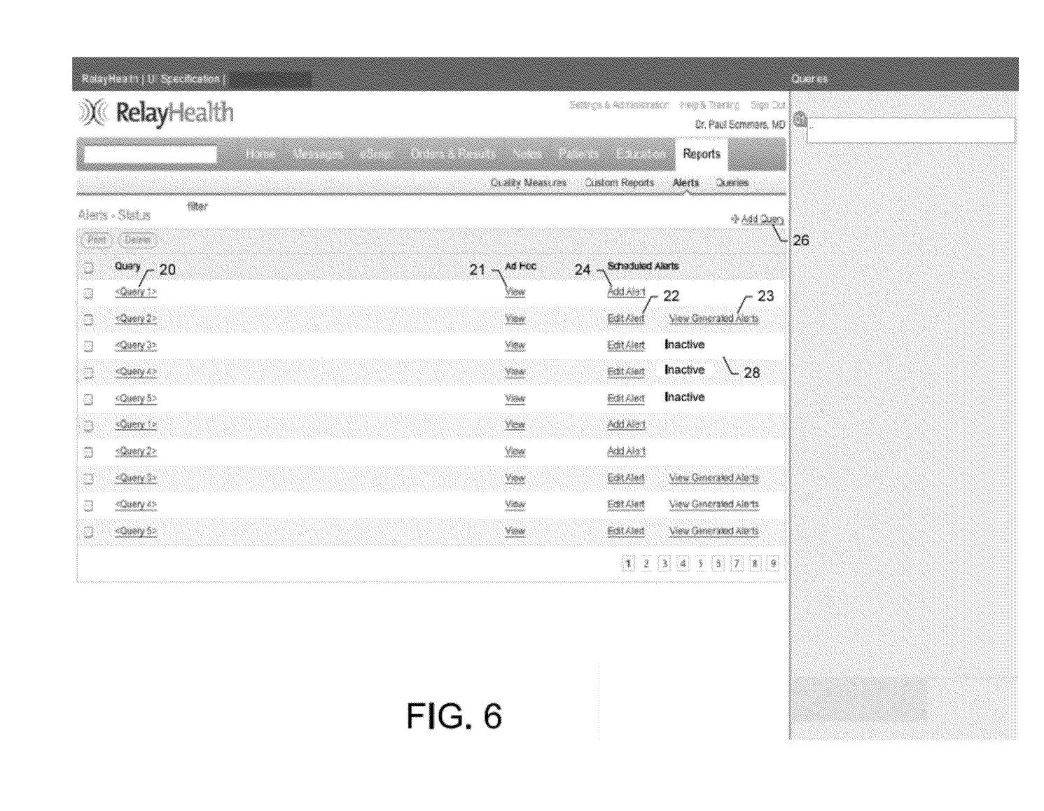

Referring now to FIG. 6, a diagram of an alert status user interface according to an exemplary embodiment is provided. In an example embodiment, the alert manager module 78 may generate the alert status user interface. In response to the alert manager module 78 receiving an indication of a selection of a link (e.g., link 20) to a query (e.g., Query 1), the alert manager module 78 may enable display of one or more defined queries for a corresponding alert(s). In this regard, the alert manager module 78 may enable display of one or more active or inactive queries. For instance, an inactive link (e.g., inactive link 28) may denote that a previously defined query (e.g., Query 3) is no longer active. In an exemplary embodiment, the inactive link 28 may also denote that a previously active alert is no longer active. Upon selection of the inactive link the alert manager module 78 may enable display of a user interface that may be utilized to reactivate a corresponding alert(s) and/or query.

On the other hand, a view generated alerts link (e.g., view generated alerts link 23) associated with a corresponding query may denote that the corresponding query is active. In an exemplary embodiment, the view generated alerts link may also denote that a corresponding alert is active. In response to receipt of an indication of a selection of a view generated alerts link, the alert manager module 78 may enable provision of display of one or more dates and times that a corresponding alert has been generated. In this regard, for example, if a corresponding alert is scheduled to be generated monthly, the alert manager module 78 may enable display of the number of times the alert has been executed in a given month and the dates that the alert was executed. A corresponding list of patients that may have been monitored on the dates may be provided by the alert manager module 78.

The alert manager module 78 may enable display of an add alert user interface in response to receipt of a selection of one or more add alert links (e.g., add alert link 24). In this regard, a user may utilize the add alert user interface to define an alert for a query.

The alert manager module 78 may also enable provision of display of one or more edit alert links (e.g., link 22) corresponding to one or more defined alerts that may be associated with the corresponding queries. In response to receipt of an indication of the links associated with the defined alerts, the alert manager module 78 may enable provision of display of a corresponding alert that may be edited. In response to receipt of an indication of a link 22 indicating that one or more alerts may not be defined for a corresponding query (e.g., Query 1), the alert manager module 78 may enable provision of display of a user interface for adding or defining a correspond alert(s).

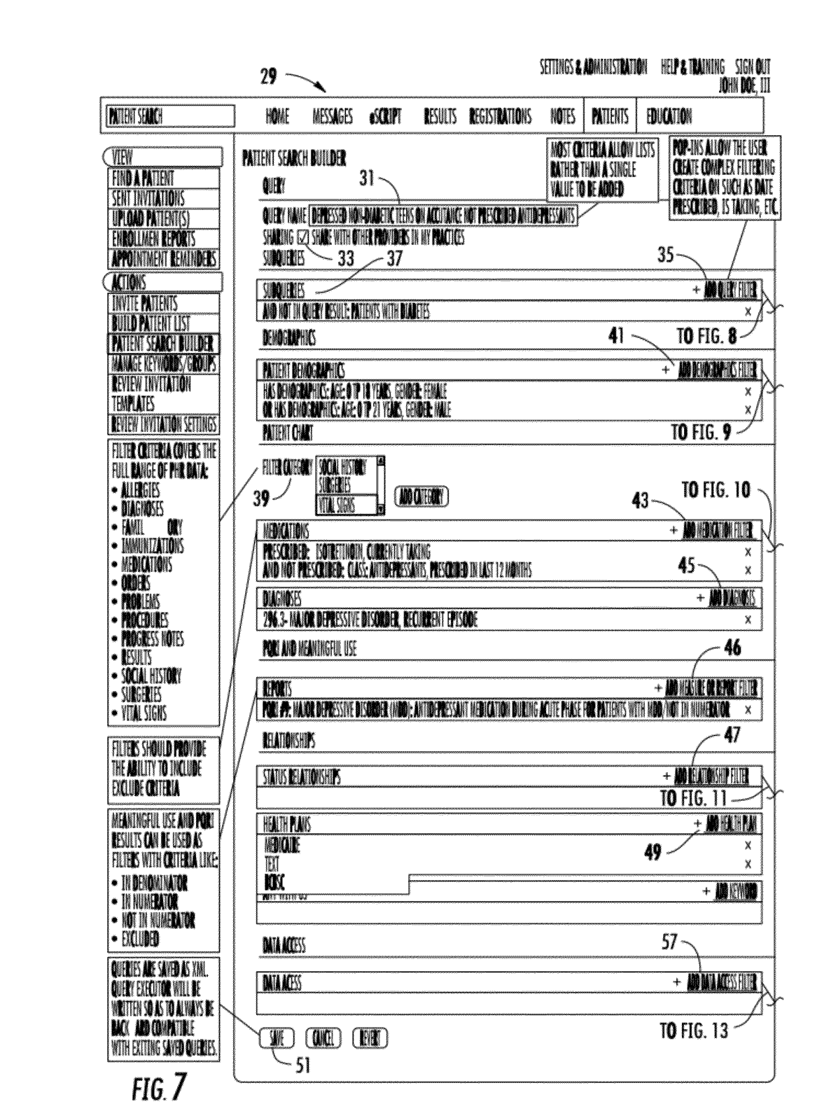

In response to receipt of an indication of a selection of an add query link 26, the alert manager module 78 may enable provision of display of a user interface for adding or building a query. (See e.g., the build query user interface 29 of FIG. 7) As such, a user may utilize a user interface (e.g., user input interface 82) in communication with the alert manager module 78 in response to receipt of the add query link 26 to build one or more queries.

The alert manager module 78 may enable display of a list of patients corresponding to a respective query and alert(s) in response to receipt of an indication of a selection of a view ad hoc link (e.g., view ad hoc link 21). As such, in response to receipt of a view ad hoc link, the alert manager module 78 may display a list of patients that are associated with a corresponding query on demand, in real time. The alert manager module 78 may also enable display of times and dates that a corresponding alert(s) was executed. In response to receipt of a selection of a time or date, the alert manager module 78 may enable display of patients that were monitored based on the alert at the corresponding date or time.

Referring now to FIG. 7, a user interface for building one or more queries according to an example embodiment is provided. In an example embodiment, the alert manager module 78 may generate the build query user interface 29 of FIG. 7. The build query user interface 29 may be utilized by one or more health care professionals to define the criteria for one or more queries. Based on the selections and choices in response to the queries provided by the build query user interface, the alert manager module 78 may generate a query definition, as described more fully below. In this regard, the build query user interface may be provided with text field 31 for defining a query name. In response to receipt of an indication of a selection 31 to share the query or a corresponding alert, the alert manager module 78 may include data in the defined query specifying that the query and/or a corresponding alert(s) may be shared with designated individuals or entities, for example. As such, a defined query and/or a corresponding alert(s) may be shared with other health care professionals (e.g., providers (e.g., other doctors)) of a medical facility (e.g., a hospital) associated with a particular health care professional. In an example embodiment a defined query and/or a corresponding alert(s) may also be shared with one or more external sources (e.g., medical entity 7). The build query user interface 29 may also include an add query filter link 35. In response to receipt of an indication of a selection of the add query link 35, the alert manager module 78 may include data in a subqueries field 37 in response to receipt of a selection indicating that a user desires to exclude patients with diabetes from the defined query. In this regard, it should be pointed out that the filters of the build query user interface 29 may be configured to include or exclude criteria. As such, one or more queries of the build query user interface 29 may include criteria for missing data elements. For purposes of illustration and not of limitation, a query may include criteria for missing data elements such as, for example, finding patients taking Avandia without a diagnosis of diabetes on record. This type of negative search may be preformed for any of the clinical data elements associated with the filters of the build query user interface 29.

In response to receipt of a selection of an add demographics filter link 41, the alert manager module 78 may enable selection of one or more patient demographics. In the example of FIG. 7, the alert manager module 78 may enable selection of male patients up to 18 years old and/or female patients up to 21 years old to be added to the defined query.

The build query user interface 29 generated by the alert manager module 78 may include a filter category 39. The filter category 39 may enable selection of one or more items of information associated with patients. Some of the items of information may be aggregated by the alert manager module 78 based on data received from multiple different entities/sources (e.g., medical 1, pharmacy 3, laboratory 5, medical entity 7, pharmacy 9, laboratory 11). In the example embodiment of FIG. 7, the filter category 39 may enable selection of any suitable items of information obtained from one or more patient charts. In this regard, the items of information may include but are not limited to, allergies, diagnosis, family history, immunizations, medications, orders, problems, procedures, progress notes, results, social history, surgeries, vital signs as well as any other suitable information. In the example embodiment of FIG. 7, the alert manager module 78 may receive an indication or a selection of vital signs to be included in the defined query.

Upon receipt of an indication of a selection of the add medication filter link 43, the alert manager module 78 may enable selection of one or more medications to be added to the defined query and/or to be excluded from the defined query. In the example of FIG. 7, the alert manager module 78 may determine medications such as, for example, isotretinoin should be included in the defined query and that mediations such as, for example, a class of antidepressants prescribed in the last twelve months should be excluded from the defined query. Upon receipt of an indication of the add diagnosis link 45, the alert manager module 78 may enable selection of one or more diagnoses. The diagnoses may be associated with one or more unique codes (e.g., NQF codes) in aggregated medical data received by the alert manager module 78 from one or more different entities (e.g., medical entity 1, pharmacy 3, laboratory 5, medical entity 7, pharmacy 9, medical entity 11). In the example embodiment of FIG. 7, the alert manager module 78 may receive an indication of a selection of a diagnosis such as, for example, a recurrent episode of major depressive disorder. The alert manager module 78 may determine that the diagnosis corresponds to a unique code (e.g., a diagnosis code (e.g., 296.3)) that indicates the diagnosis of a patient. The unique code may be in medical data received from one or more different entities/sources. In an example embodiment, the codes corresponding to one or more diagnoses may include, but are not limited to, ICD-9 codes. In an example embodiment, the alert manager module 78 may identify one or more diagnoses based on the unique codes or based on a description associated with the diagnoses.

In response to receipt of an indication of a selection of the add measure or report filter link 46, the alert manager module 78 may enable selection of one or more reports to be added to or excluded from a defined query. The reports may correspond to one or more unique codes indicating a type of report. The codes (e.g., PQRI codes, etc.) may also include, or otherwise be associated with, one or defined measures (e.g., a measure (e.g., a medical test) for diabetes). The measures may be standard measures that may be recommended to be performed for a corresponding medical condition. The measures may be associated with data identifying a goal (e.g., an ideal value of an insulin test) for meeting the measures. The codes associated with the reports may be received by the alert manager module 78 from one or more different entities/sources. The codes may be included in data corresponding to a particular patient. In the example of FIG. 7, the alert manager module 78 may determine that a report corresponding to a code (e.g., a PQRI #9 code) relating to major depressive disorder (MDD) may be included in a defined query. It should also be pointed out that the codes may be associated with numerator criteria and denominator criteria. The numerator criteria may relate to patients (e.g., a percentage of patients) that meet the corresponding measure(s) associated with a code(s). The denominator criteria may relate to the patient population that is qualified to be included in the particular measure (e.g., patients diagnosed with diabetes for a diabetes measure). In an example embodiment, the numerator criteria and/or the denominator criteria associated with one or more codes may be included or excluded from the defined query. For instance, in the example embodiment of FIG. 7, the numerator criteria associated with the PQRI code #9, relating to major depressive disorder, may not be included in the defined query since the alert manager module 78 may detect receipt of an indication of a selection of data (e.g., text denoting “NOT IN NUMERATOR”) indicating that the numerator criteria should not be included in the defined query. As such, the alert manager module 78 may identify patient reports for patients that do not meet the corresponding measure when the defined query is complete and executed.

It should also be pointed out that the alert manager module 78 may allow the goals associated with standard measures related to the codes to be altered. In this regard, if a health care professional desires to lower or increase a goal(s) associated with a defined measure, the health care professional may utilize a user input interface (e.g., user input interface 82) to input data indicating the changed goal(s) and in response to receipt of the data, the alert manager module 78 may change the goal(s).

Upon receipt of an indication of a selection of the add relationship filter link 47, the alert manager module 78 may enable selection of one or more status relationships. In an example embodiment, the status relationship may include, but is not limited to, data indicating whether a particular patient(s) is online or offline. In an instance in which the alert manager module 78 may receive an indication of a selection that a patient is online, the alert manager module 78 may determine that the patient has access to a patient portal (e.g., a web page) and that the patient(s) may access the portal (e.g., by logging into the portal) to obtain access to their health record data. On the other hand, in an instance in which the alert manager module 78 may receive an indication of a selection that the patient(s) is offline, the alert manager module 78 may determine that the patient does not have access to the patient portal to obtain access to their health record data.

In response to receipt of an indication of a selection of the add health plan filter 49, the alert manager module 78 may enable selection of one or more health plans to be included in a defined query. Additionally, upon receipt of an indication of a selection of the add data access filter link 57, the alert manager module 78 may enable selection of date criteria that the alert manager module 78 may utilize to evaluate history information associated with one or more records of patients. In response to receipt of an indication of a selection of the date criteria, the alert manager module 78 may include the date criteria for evaluating the history information in the defined query. Upon receipt of an indication of a selection of the save button 51, the alert manager module 78 may generate a defined query (also referred to herein as query definition) based on the selections and choices made via the build query user interface 29 and may save the defined query in a memory (e.g., memory 86). In this regard, the defined query may be complete.

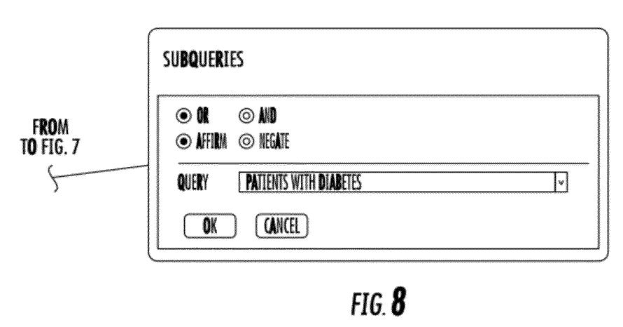

Referring now to FIGS. 8-13, exemplary embodiments of user interfaces associated with the build query user interface are provided. Referring to FIG. 8, a subqueries user interface may be generated by the alert manager module 78 in response to receipt of a selection of the add query filter link 35. In this regard, the alert manager module 78 may enable selection of one or more queries from a pull down menu, or the like. The alert manager module 78 may designate that the selected quer(ies) may be excluded from the defined query in response to receipt of a selection of the negate button. As such, in the example of FIG. 8, the alert manager module 78 may indicate that patients with diabetes are to be excluded from the defined query. In response to the alert manager module 78 receiving an indication of a selection of the OK button, the alert manager module 78 may save the selected subquery in a memory (e.g., memory 86).

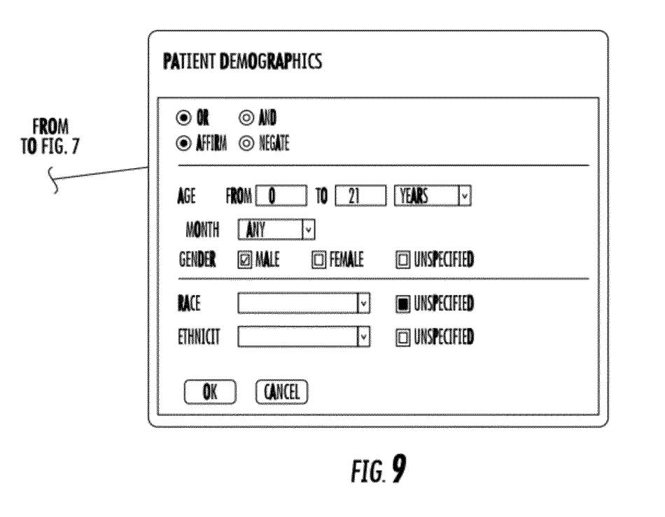

Referring to FIG. 9, a patient demographics user interface may be generated by the alert manager module 78 in response to receipt of an indication of a selection of the add demographics filter link 41. In this regard, the alert manager module 78, may receive indications of selections of criteria corresponding to a group or set of patients. The criteria may include an age range, gender, race and ethnicity. The criteria may, but need not, be defined for a selected month. Upon receipt of an indication of the OK button, the alert manager module 78 may save the selected patient demographics. The alert manager module 78 may save the patient demographics to a memory (e.g., memory 86). The alert manager module 78 may also include the selected patient demographics in a defined query.

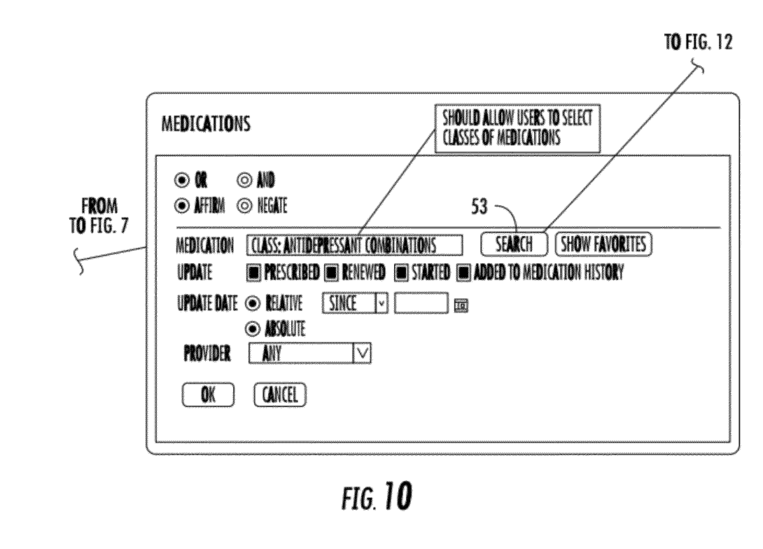

Referring now to FIG. 10, a medications user interface may be generated by the alert manager module 78 in response to receipt of an indication of a selection of the add medication filter link 43. In this regard, the alert manager module 78 may receive indications of one or more selections associated with one or more medications and/or one or more classes of medications (e.g., a class of antidepressant combinations). In response to receipt of an indication of a selection of the OK button, the alert manager module 78 may save the selected medication data to a memory (e.g., memory 86) and may include the selected medication data in a defined query.

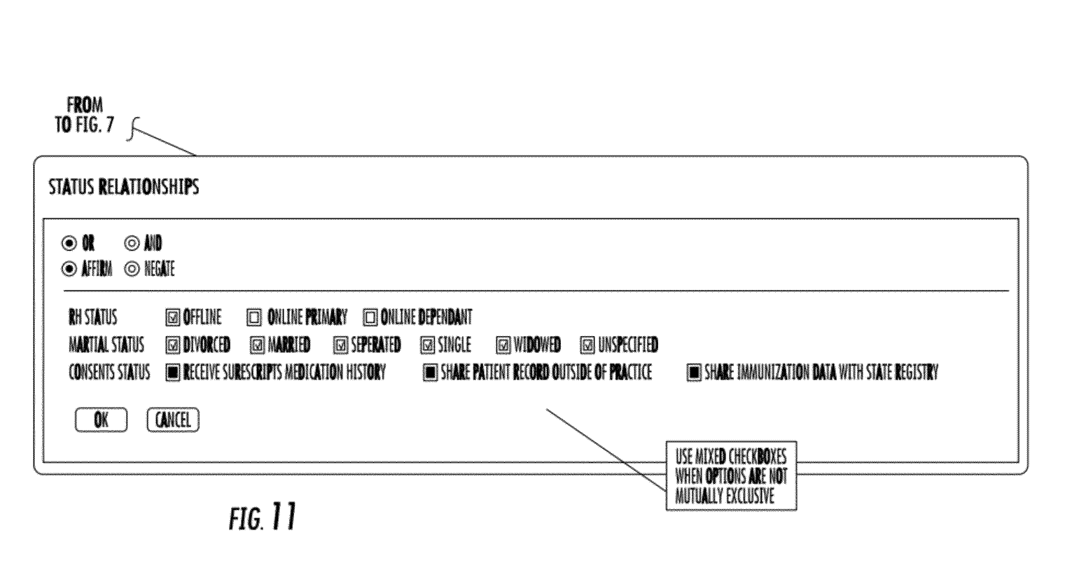

Referring to FIG. 11, a status relationships user interface may be generated by the alert manager module 78 in response to receipt of one or more indications of selections relating to a patient's status with an entity (also referred to herein as “RH status”) (e.g., health care entity 12), marital status and consent status. In the example of FIG. 11, selected patient status relationships may include patients that may be designated as offline, divorced, married, separated, single, widowed and unspecified with respect to marital status. In this regard, the alert manager module 78 may store the selections in a memory (e.g., memory 86) in response to receipt of an indication of the OK button. Upon receipt of an indication of a selection of the OK button, the selections may be included in a defined query by the alert manager module 78.

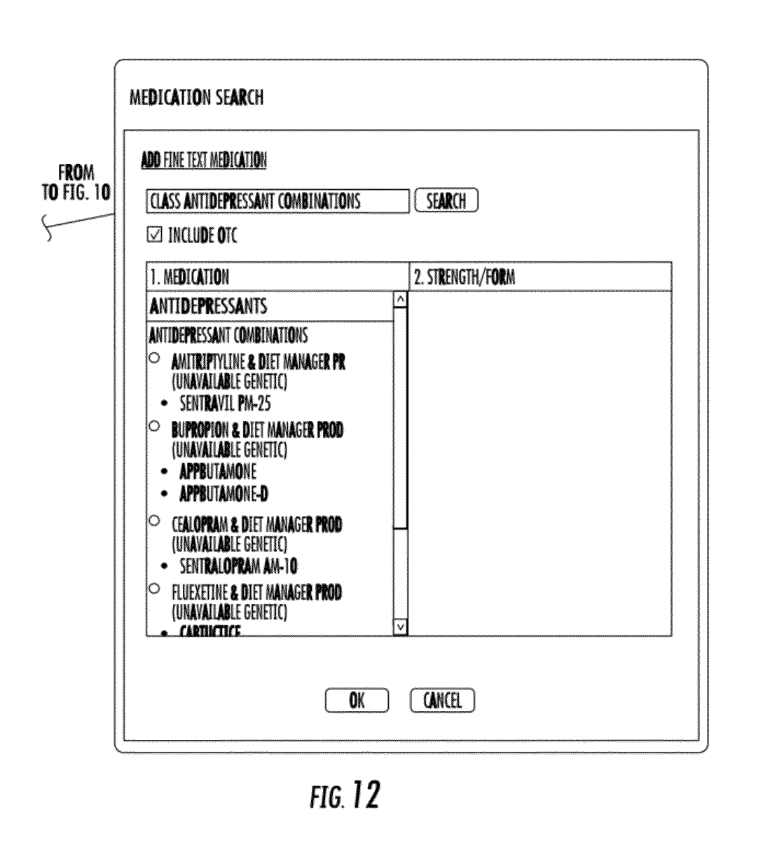

Referring now to FIG. 12, a medication search user interface may be generated by the alert manager module 78 in response to receipt of an indication of the search tab 53. (See e.g., FIG. 10). The alert manager module 78 may receive data associated with one or more chosen medications or chosen class of medications (e.g., a class of antidepressant combinations). In this regard, the alert manager 78 may search a memory (e.g., memory 86) for data related to chosen medications or classes of chosen medications in response to receipt of an indication of the OK button.

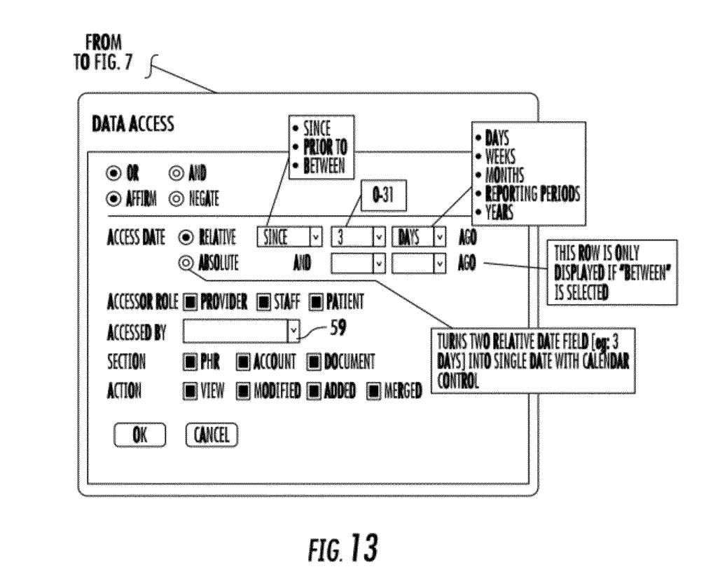

Referring now to FIG. 13, a data access user interface may be generated by the alert manager module 78 in response to receipt of an indication of a selection of the data access filter link 57. The data access user interface may be utilized to select date criteria that the alert manager module 78 may utilize in order to evaluate historical information associated with one or more records of patients. In this regard, the alert manager module 78 may determine if one or more records have been accessed and may determine the number of times the records have been accessed during a time period corresponding to the selected date criteria. For example, the alert manager module 78 may determine whether there have been any activities indicated in one or more patient records during a time period corresponding to the selected date criteria. The alert manager module 78 may determine the identity of one more or individuals accessing the records and may determine the type of activities indicated. The alert manager module may determine an identity of the individuals accessing the records in response to receipt of an indication of a selection of an individual identified in a pull down menu 59.

In response to receipt of an indication of a selection of the OK button, the alert manager module 78 may save the selected date criteria to a memory (e.g., memory 86) and may include the selected date criteria, for evaluating historical data, in a defined query.

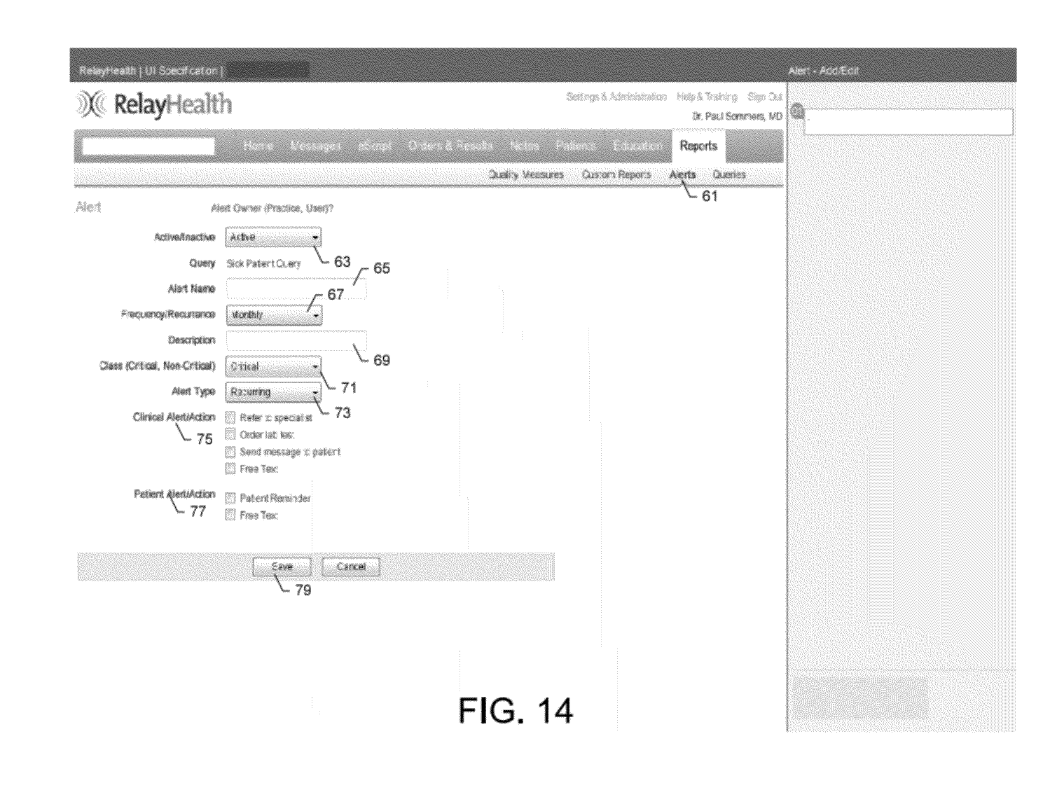

Referring now to FIG. 14, a set alert user interface according to an exemplary embodiment is provided. In an example embodiment, a health care professional(s) may utilize the set alert user interface to enable the alert manager module to generate a customizable health care alert on behalf of a health care professional(s). The alert manager module 78 may generate the set alert user interface in response to receipt of an indication of an alerts link 61. The set alert user interface may be utilized to generate an alert(s) based on a defined query. In order to set an alert(s), the set alert user interface may enable selection of a defined query. In the example of FIG. 14, the set alert user interface may enable selection of a defined query such as, for example, a Sick Patient Query. In another alternative embodiment, the set alert user interface may enable selection of the Depressed Non-Diabetic Teens on Accuatane Not Prescribed Antidepressants Query defined in FIG. 7.

In response to receipt of a selection from a pull down menu 63, the alert manager module 78 may make the query active (e.g., the Sick Patient Query). In this regard, the alert manager module may actively use the query to generate a customizable health care alert. In response to receipt of input received from a user input interface (which may be entered by a user (e.g., a health care professional (e.g., physician))), the alert manager module 78 may input a name in the alert name field 65. The alert manager module 78 may set the frequency or recurrence for generating the alert in response to receipt of a selection associated with the frequency/recurrence pull down menu 67. In the example of FIG. 14, the alert manager module 78 may set the frequency or recurrence for generating the alert to monthly. However, the alert manager module 78 may set the frequency according to any other suitable frequency (e.g., weekly, etc.).

One or more notes may be entered into the description field 69, by the alert manager module 78, based on receipt of information from a user input interface (e.g., user input interface 32). For example, the description field 69 may indicate a kind of alert (e.g., a practice level alert) desired by a health care professional. The alert manger module 78 may designate the alert as critical or non-critical in response to receipt of a selection from the pull down menu 71. In response to receipt of a selection from the alert type pull down menu 73, the alert manager module 78 may define a type or category of the alert. In this example embodiment, the alert manager module 78 may define the alert type as recurring. In response to receipt of indications of one or more clinical alert/actions 75, the alert manager module 78 may define one or more corresponding automated actions for the alert being defined.

For instance, in response to receipt of an indication that the refer to specialist action is selected, the alert manager module 78 may generate a message that may automatically be sent to the patients corresponding to the alert being defined and the message may include data recommending a specialist for a patient to visit. In an instance in which the order lab test action is selected, the alert manager module 78 may automatically order a lab test to be performed on behalf of the patients corresponding to the alert being defined. In response to receipt of an indication that the send message to patient action is selected, the alert manager module 78 may send a message (e.g., an email message, Short Messaging Servicing (SMS) message, Multimedia Messaging Service (MMS) message, etc.) to the patients. Upon receipt of a selection of the free text action associated with the clinical alert/action, the alert manager module 78 may enable a prompt to be provided to a device (e.g., electronic device 100) of a health care professional in order to enter free text for the description of a message to be sent to patients.

In response to receipt of a selection of the patient reminder action associated with the patient action/alert, the alert manager module 78 may send a reminder message to the corresponding to patients associated with the alert being defined. The reminder message may include predefined data specifying the nature of the reminder (e.g., patient(s) is two weeks overdue for taking a lab test). In response to receipt of an indication of the free text action associated with the patient alert/action 77, the alert manager module 78 may specify the text to be included in the reminder messages to be sent to patients associated with the alert being defined. Also, in response to receipt of a selection of the free text action, the alert manager module 78 may enable display of options for the reminder message being sent to the patient in an email message, SMS message, MMS message or alternatively being provided in a phone call, letter or the like to the corresponding patients. The reminder message may be sent to the corresponding patients according to any other suitable mechanism. The alert manager module 78 may save the defined alert in response to receipt of an indication that the save button 79 is selected.

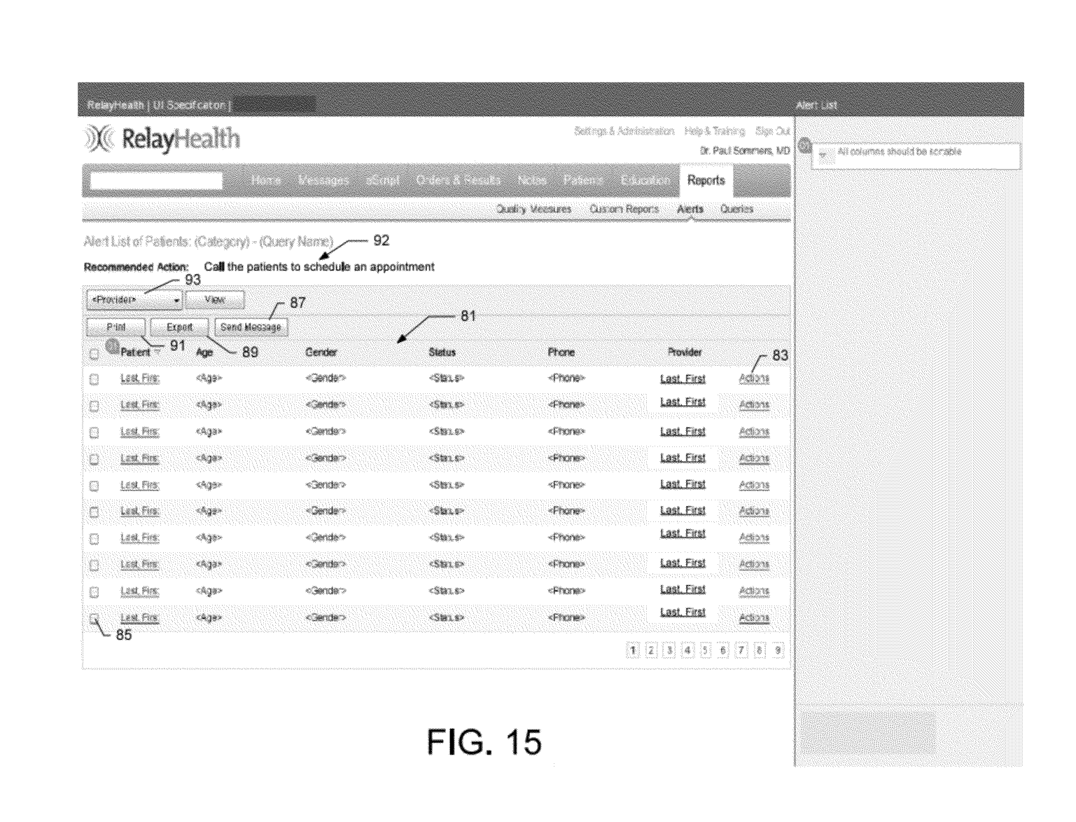

Referring now to FIG. 15, a report output user interface according to an example embodiment is provided. The alert manager module 78 may generate the report output user interface. The report output user interface may relate to one or more reports that may be generated based on the frequency of occurrence (e.g., monthly, weekly) defined for a corresponding alert(s). In this regard, the alert manager module 78 may include a category for the list of patients associated with the alert(s) and a corresponding query name (e.g., Sick Patient Query) associated with the alert. The recommended actions field 92 may indicate that there is a recommended action(s) associated with the corresponding alert(s). The recommended action(s) may indicate an action(s) to be performed for all the patients in the list 81. In the example of FIG. 15, the alert manager module 78 may determine that the recommended action is to call all the patients in the list and schedule an appointment. The alert manager module 78 may determine the recommended action(s) for all patients in the list based on a defined set of actions to be performed in association with the corresponding alert. The defined set of actions may be stored in a memory (e.g., memory 86).

The alert manager module 78 may generate the list 81 of patients when the corresponding alert(s) is run or executed based on the frequency defined for the alert. The list of patients may relate to the set or group of patients established by the criteria of a query definition. For example, the set of patients meeting the query definition established by the build query user interface. In this regard, the alert manager module 78 may provide the names, ages, genders, statuses (e.g., online patient or offline patient), phone numbers and providers (e.g., primary care physician) corresponding to the patients in the list 81.

In the example of FIG. 15, the corresponding alert(s) may be a practice level alert defined for multiple providers in a health care institution (e.g., a medical clinic). In response to receipt of an indication of an actions link (e.g., actions link 83), the alert manager module 78 may enable provision of display of user interface with information tracking the status one or more defined actions that are to be performed for a corresponding patient. The actions may be defined as automated or manual actions. In this regard, in the example of FIG. 15, the alert manager module 78 may determine that the status indicates that a health care professional (e.g., a nurse) called and left a message for a patient. Based on the recommended action of the report output user interface of FIG. 15, the alert manager module 78 may determine that now the health care professional needs to call the patient for an appointment. In an alternative embodiment, for example, the alert manager module 78 may determine that the status indicates that an automated message was sent to the corresponding patient and was confirmed as received.

In response to receipt of an indication that one or more check boxes (e.g., check box 85) are selected and an indication that the send message button 87 is selected, the alert manager module 78 may send a message to the selected patients associated with the selected check boxes. In this regard, for patients whose status indicates that they are online, the alert manager module 78 may send the message to these patients at the same time. The alert manager module 78 may print the list 81 of patients in response to receipt of an indication of a selection of the print button 91. In addition, the alert manager module 78 may export the results of the list 81 in response to receipt of an indication of a selection of the export button 89. For purposes of illustration and not of limitation, the alert manager module 78 may export the results of the list 81 to a software application (e.g., a spreadsheet program (e.g., Excel™ program)) or the like. However, the alert manager module may export the list 81 to any other suitable source in response to receipt of an indication of a selection of the export button.

The provider pull down menu 93, generated by the alert manager module 78, may enable selection of filters for a specific provider (e.g., a doctor) or all providers (e.g., all doctors) of a health care institution (e.g., a medical clinic). In the example embodiment of FIG. 15, an “all” option may be selected from the provider pull down menu 93 indicating the name of a provider (e.g., doctor) for each patient. In an alternative example embodiment, in an instance in which one provider may be chosen from the provider pull down menu 93, the alert manger module 78 may enable generation of a list (e.g., list 81) with all patients of the selected provider.

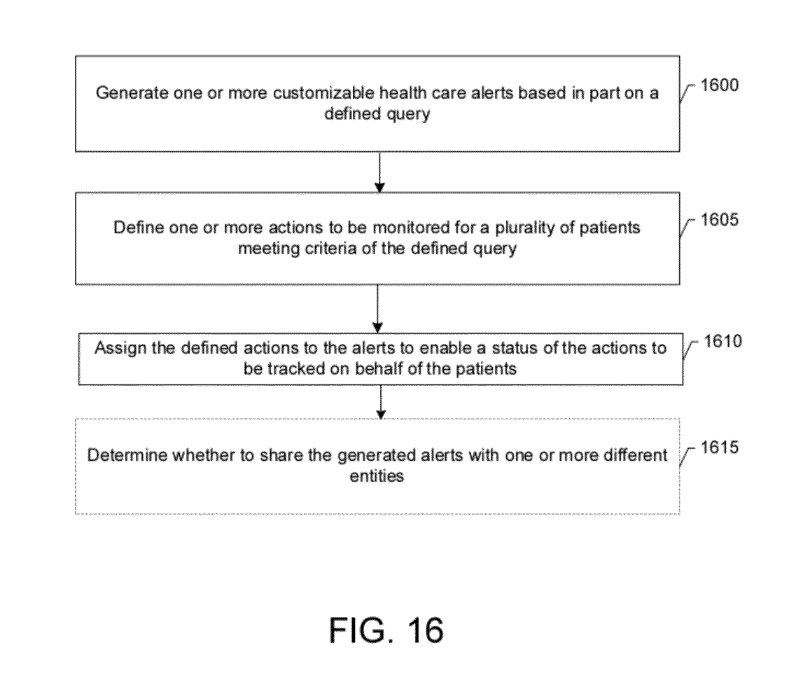

Referring now to FIG. 16, a flowchart for generating one or more customizable health care alerts according to an exemplary embodiment is provided. At operation 1600, an apparatus (e.g., alert manager module 78) may generate one or more customizable health care alerts based in part on a defined query. The defined query may be generated based in part on receipt of response to queries provided by the build query user interface 29. At operation 1605, the apparatus may define one or more actions to be monitored for a plurality of patients meeting criteria of the defined query. At operation 1610, the apparatus may assign the defined actions to the alerts to enable a status of the actions to be tracked on behalf of the patients. Optionally, at operation 1615, the apparatus may determine whether to share the generated alerts with one or more different entities. The different entities may include, but are not limited to, medical entity 1, pharmacy 3, laboratory 5, medical entity 7, pharmacy 9, laboratory 11, etc.

It should be pointed out that FIGS. 4 & 16 are flowcharts of a system, method and computer program product according to exemplary embodiments of the invention. It will be understood that each block or step of the flowcharts, and combinations of blocks in the flowcharts, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory 86, memory 36) and executed by a processor (e.g., processor 70, processor 34, alert manager module 78). As will be appreciated, any such computer program instructions may be loaded onto a computer or other programmable apparatus (e.g., hardware) to produce a machine, such that the instructions which execute on the computer or other programmable apparatus cause the functions specified in the flowcharts blocks or steps to be implemented. In some embodiments, the computer program instructions are stored in a computer-readable memory that can direct a computer or other programmable apparatus to function in a particular manner, such that the instructions stored in the computer-readable memory produce an article of manufacture including instructions which implement the function specified in the flowcharts blocks or steps. The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts blocks or steps.

Accordingly, blocks or steps of the flowcharts support combinations of means for performing the specified functions and combinations of steps for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In an exemplary embodiment, an apparatus for performing the methods of FIGS. 4 & 16 above may comprise a processor (e.g., the processor 70, the processor 34, the alert manager module 78) configured to perform some or each of the operations described above. The processor may, for example, be configured to perform the operations by performing hardware implemented logical functions, executing stored instructions, or executing algorithms for performing each of the operations. Alternatively, the apparatus may comprise means for performing each of the operations described above. In this regard, according to an example embodiment, examples of means for performing operations may comprise, for example, the processor 34, the processor 70 (e.g., as means for performing any of the operations described above), the alert manager module 78 and/or a device or circuit for executing instructions or executing an algorithm for processing information as described above.

### Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation

That which is claimed:

1. A method comprising:
generating one or more customizable health care alerts based in part on a defined query;
defining, via a processor, one or more actions to be monitored for a plurality of patients meeting criteria of the defined query; and
assigning the defined actions to the generated alerts to enable a status of the actions to be tracked.

2. The method of claim 1, further comprising, determining whether to share the generated alerts with one or more different entities.

3. The method of claim 2, further comprising:
sharing at least one of the generated alerts with at least one of the entities based in part on detection of a definition, associated with the alerts, specifying that the alerts are to be shared with the at least one entity;
enabling a device of the at least one entity to customize the alerts by implementing at least one change to a definition associated with the generated alerts.

4. The method of claim 1, further comprising:
enabling tracking of the status of each of the actions in response to execution of the generated alerts based on a frequency of occurrence defined for the alerts, wherein the status indicates whether performance of the actions are complete.

5. The method of claim 1, further comprising:
executing the alerts to obtain one or more results based on a frequency of occurrence defined for the alerts; and
automatically sending devices of at least a portion of the patients a message based on the results.

6. The method of claim 5, further comprising:
enabling provision of the results to a device for consideration by one or more health care professionals; and
determining at least one action to be performed by at least one of the health care professionals on behalf of the patients.

7. The method of claim 1, wherein prior to generating the customizable health care alerts, the method further comprises:
generating the defined query based in part on data provided in response to one or more queries and aggregated medical data, associated with the patients, received from different entities.

8. The method of claim 7, wherein generating the defined query, further comprises generating the defined query based in part on detection of a selection of at least one code associated with data identifying one or more standard measures to be performed based on at least one determined medical condition of the patients, wherein the measures are associated with one or more corresponding goals for meeting criteria of the measures.

9. An apparatus comprising:
at least one memory; and
at least one processor configured to cause the apparatus to:
generate one or more customizable health care alerts based in part on a defined query;
define one or more actions to be monitored for a plurality of patients meeting criteria of the defined query; and
assign the defined actions to the generated alerts to enable a status of the actions to be tracked.

10. The apparatus of claim 9, wherein the processor is further configured to cause the apparatus to:
determine whether to share the generated alerts with one or more different entities.

11. The apparatus of claim 10, wherein the processor is further configured to cause the apparatus to:
share at least one of the generated alerts with at least one of the entities based in part on detection of a definition, associated with the alerts, specifying that the alerts are to be shared with the at least one entity;
enable a device of the at least one entity to customize the alerts by implementing at least one change to a definition associated with the generated alerts.

12. The apparatus of claim 9, wherein the processor is further configured to cause the apparatus to:
enable tracking of the status of each of the actions in response to execution of the generated alerts based on a frequency of occurrence defined for the alerts, wherein the status indicates whether performance of the actions are complete.

13. The apparatus of claim 9, wherein the processor is further configured to cause the apparatus to:
execute the alerts to obtain one or more results based on a frequency of occurrence defined for the alerts; and
automatically send devices of at least a portion of the patients a message based on the results.

14. The apparatus of claim 13, wherein the processor is further configured to cause the apparatus to:
enable provision of the results to a device for consideration by one or more health care professionals; and
determine at least one action to be performed by at least one of the health care professionals on behalf of the patients.

15. The apparatus of claim 9, wherein prior generate the customizable health care alerts, the processor is further configured to cause the apparatus to:
generate the defined query based in part on data provided in response to one or more queries and aggregated medical data, associated with the patients, received from different entities.

16. The apparatus of claim 15, wherein the processor is further configured to cause the apparatus to:
generate the defined query by generating the defined query based in part on detection of a selection of at least one code associated with data identifying one or more standard measures to be performed based on at least one determined medical condition of the patients, wherein
the measures are associated with one or more corresponding goals for meeting criteria of the measures.

17. A computer program product comprising at least one computer-readable storage medium having computer-executable program code instructions stored therein, the computer executable program code instructions comprising:
program code instructions configured to generate one or more customizable health care alerts based in part on a defined query;
program code instructions configured to define one or more actions to be monitored for a plurality of patients meeting criteria of the defined query; and
program code instructions configured to assign the defined actions to the generated alerts to enable a status of the actions to be tracked.

18. The computer program product of claim 17, further comprising, program code instructions configured to determine whether to share the generated alerts with one or more different entities.

19. The computer program product of claim 18, further comprising:
program code instructions configured to share at least one of the generated alerts with at least one of the entities based in part on detection of a definition, associated with the alerts, specifying that the alerts are to be shared with the at least one entity;
enable a device of the at least one entity to customize the alerts by implementing at least one change to a definition associated with the generated alerts.

20. The computer program product of claim 17, further comprising:
program code instructions configured to enable tracking of the status of each of the actions in response to execution of the generated alerts based on a frequency of occurrence defined for the alerts, wherein the status indicates whether performance of the actions are complete.
